(19) United States
(12) Patent Application Publication
(10) Pub. No.: US 2003/0076190 A1
(43) Pub. Date: Apr. 24, 2003

(54) Tamdem crossbar switch with ultra low crosstalk

(76) Inventors: William L. Clarke, Soquel, CA (US); Jules D. Levine, Santa Clara, CA (US); Stan Freske, San Jose, CA (US)

Correspondence Address: PATENT ADMINSTRATOR, KATTEN MUCHIN ZAVIS ROSENMAN, 525 WEST MONROE STREET, SUITE 1600, CHICAGO, IL, 60661-3693, US

(21) Appl. No.: 09/993,558

(22) Filed: Nov. 27, 2001

Related U.S. Application Data
(60) Provisional application No. 60/328,793, filed on Oct. 15, 2001.

(51) Int. Cl. H01P 1/15

(52) U.S. Cl. 333/101; 333/103; 333/104

(57) ABSTRACT

Switching apparatus and method in an array having plural inputs and plural outputs crossing each other at a plurality of crosspoints. First and second tandem switches are disposed at each crosspoint, between a respective input and a respective output. A shunt capacitor is coupled to each first and second switch and to ground, to short crosstalk in the inputs and outputs. A method of making a semiconductor switch array is also provided.

This application claims priority to Application No. 60/328,793 filed Oct. 15, 2001, incorporated herein by reference.

### BACKGROUND

1. Field of the Invention

The present invention relates to switching array method and apparatus capable of high signal speeds and dense integration, but with ultra low crosstalk. Preferably, the tandem switch array can switch up to 40 Gbs signals in a 1K×1K array, with 20 dB improvement in the SNR (signal-to-noise ratio).

2. Related Art

Optical Cross Connects (OXCs) are used in a variety of applications whenever fiber optic lines are linked to each other in rings and networks, either for backbone cross country applications or for metropolitan applications. There is a need for an OXC telecommunication switch which has high bandwidth, high port count, wavelength conversion and low latency. An example of a technology that offers such features is described in a TeraBurst Networks publication by J. D. Levine, T. Myers, R. LaRue, L. Raman and S. Mitra, entitled “A New Technology for Optical Cross Connects”, in National Fiber Optical Engineering Conference Proceedings, NFOEC 2001, Baltimore, Md. (incorporated herein by reference). Scaleup of this technology to an OXC crossbar switch array with high port count of the order of 1024×10²⁴ requires ultra low crosstalk between rows and columns since there are 1024 switches in a line. Previously, it was thought that the only way to do this was to reduce the geometry and related coupling capacitance of each switch at each node of a crossbar switch array to near zero, but there are limits to lithography and yield. As a result, the usual designs cannot approach the goal of 1024×10²⁴ port sizes.

A typical N×M analog crossbar switch (FIG. 1) comprises N parallel transmission lines 12₁, 12₂, . . . 12_{N} (forming N rows), and M parallel output lines 14₁, 14₂, . . . 14_{M} (forming M columns) which are usually disposed in a perpendicular orientation with respect to the rows. Terminations 13 are typically provided at the terminations of the rows 12 and columns 14. At each of the N×M crossbar points 15, there is located a means (i.e., a switch element) 16_{(1,1)}, . . . 16_{(N,M)}, which allows a signal incoming on a row to be directed to an arbitrary column. Used as a permutation switch, this structure is intrinsically broadband and non-blocking, providing a cost effective switching solution which is able to operate at bandwidths over 40 Gbs (40×10⁹ bits per second), and able to scale to large arrays, e.g., 1K×1K.

The basic crossbar switch design typically uses a simple ON-OFF switch (such as a single thyristor) as the switch element 16 at the crosspoints 15. For any given row and column, only one crosspoint switch 16 is usually ON at any given time, and the rest are usually OFF. Hence, for any given signal, the other (N-1) signal inputs will be partially coupled into the signal path by the parasitic capacitance of the OFF thyristor switches 16. Since the inputs are pseudo random sources, this coupled crosstalk will appear as noise on the signal path, reducing the signal to noise ratio (SNR) of the switch, and leading to bit errors. Forward Error Correction (FEC) techniques (see, for example, “FEC Performance Analysis Data Sheet S3062”, Applied Micro Circuits Corporation, San Diego, Calif., Apr. 13, 2000; incorporated herein by reference) can sometimes suppress these bit errors, but this requires complex digital circuitry with large demands on system power consumption and real estate.

For a basic analog crossbar switch which uses single crosspoint switches, the spurious crosstalk power coupled into a given signal output for a unit signal input due to the coupling of any of the other (N-1) input signals is given by

CP(f)=(¼)(2πfCZ₀)²/[1+(2ππCZ₀)²)] (1)

where

2πf is the angular frequency

C=parasitic capacitance of an OFF crosspoint switch

Z₀=characteristic impedance of the lines.

The signal output will also be attenuated by the switch. The signal power at the output of the switch given an input signal with unit power is

SP(f)=(¼)(Z₀)²/[R+Z₀]² (2)

Where

R=ON resistance of the thyristor crosspoint switch

Z₀=characteristic impedance of the lines.

For example, for a band limited input signal incoming on row 1 of an N×M crossbar switch and outgoing on the last column (i.e., column M), there will be cross coupling from all of the other signals incoming on rows 2, 3, . . . N, each of which will be coupled with a strength approximately given by equation (1). Assuming that this coupled crosstalk can be characterized by Gaussian noise (see “Mathematical Methods in the Physical Sciences”, M.L. Boas. Wiley and Sons, 1983, Page 723, incorporated herein by reference), then the variance of the of the total crosstalk power coupled into column M is:

$${σ}^{2} = ( N - 1 ) 1 / {f}_{m} {\int }_{0}^{fm} CP ( f ) ⅆ f \qquad ( 3 )$$

where

fₘ is the band limit (maximum) frequency

CP(f) is the crosstalk power given by equation (1).

A switch signal to noise ratio can be defined as:

SNR=S/σ (4)

where

S is the peak output signal power at the maximum signal frequency

σ is the square root of the variance given by equation (3).

Accordingly, what is needed is a switching array which reduces crosstalk, thus increasing signal throughput and allowing for greater integration density.

### SUMMARY OF THE INVENTION

The present invention is capable of providing an OXC where the coupling capacitance between each intersecting row and column is reduced to near zero, preferably by means of a tandem structure involving two switch elements in series with a capacitor shunt to ground at the midpoint. The reduced capacitance has an additional benefit that the frequency of signals transported through the switch fabric can be increased as well. There is a demand for OC-768 network switches (OC stands for optical carrier and the number affixed is the multiple of the base rate bandwidth of 51.85 Mbps) operating at or near 40 GHz with a large array size and this is made possible with the invention described below.

It is thus an object of the present invention to provide a ultra low loss switching array having superior signal-to-noise, able to switch signals at a very high speed, and capable of dense integration.

According to a first aspect of the present invention, telecommunications switching apparatus and method for an array having a plurality of inputs and a plurality of outputs includes structure and/or function whereby a plurality of switching elements is disposed such that each is coupled to a respective input and to a respective output. Shunt capacitance structure is coupled to the switching elements to suppress crosstalk between the inputs and the outputs.

According to another aspect of the present invention, microwave switching apparatus and method, in an array having plural inputs and plural outputs crossing each other at a plurality of crosspoints, includes structure and/or function whereby a plurality of first switches is provided such that each is disposed at a corresponding crosspoint between a respective input and a respective output. A plurality of second switches is disposed such that each is connected in series with a respective first switch. Preferably, a shunt capacitor is coupled to the first and second switches to ground spurious noise.

According to a further aspect of the present invention, a microwave switch array and method includes structure and/or function whereby a plurality of signal inputs is disposed on a substrate. A plurality of signal outputs is disposed on the substrate and crossing the plurality of signal inputs at a plurality of crosspoints. A plurality of tandem semiconductor switches are respectively disposed at the crosspoints, each tandem switch comprising first and second series-connected switches. A plurality of semiconductor shunt capacitance elements are respectively disposed at the crosspoints and coupled to respective first and second switches and to ground, to ground noise signals.

According to yet another aspect of the present invention, a method of making a low-loss microwave switch array, includes the steps of: (i) providing a substrate; (ii) forming a plurality of signal inputs on said substrate; (iii) forming a plurality of signal output on said substrate and crossing said plurality of signal inputs at a plurality of crosspoints; (iv) forming a plurality of tandem semiconductor switches respectively disposed at the crosspoints, each tandem switch comprising first and second series-connected switches; and (v) forming a plurality of semiconductor shunt capacitance elements respectively at the crosspoints and coupled to respective first and second switches and to ground.

### BRIEF DESCRIPTION OF THE DRAWINGS

FIG. 1 is a schematic diagram of a typical N×M Crossbar Switch array.

FIG. 2 is a schematic diagram of one switch node according to a preferred embodiment of the present invention.

FIG. 3 is a schematic diagram of an equivalent circuit of the FIG. 2 embodiment when the thyristors are OFF.

FIG. 4 is a schematic diagram of an equivalent circuit of the FIG. 2 embodiment when the thyristors are ON.

FIG. 5 is a top plan view of a Silicon on Glass (SOG) implementation according to a preferred embodiment of the present invention.

FIG. 6 is a side view of the FIG. 5 implementation.

FIG. 7 is another side view of the FIG. 5 implementation.

FIG. 8 is a side view of a microstrip implementation according to the present invention.

FIG. 9 is another side view of the microstrip implementation according to the present invention.

### DETAILED DESCRIPTION OF THE PRESENTLY PREFERRED EMBODIMENTS

1. Introduction

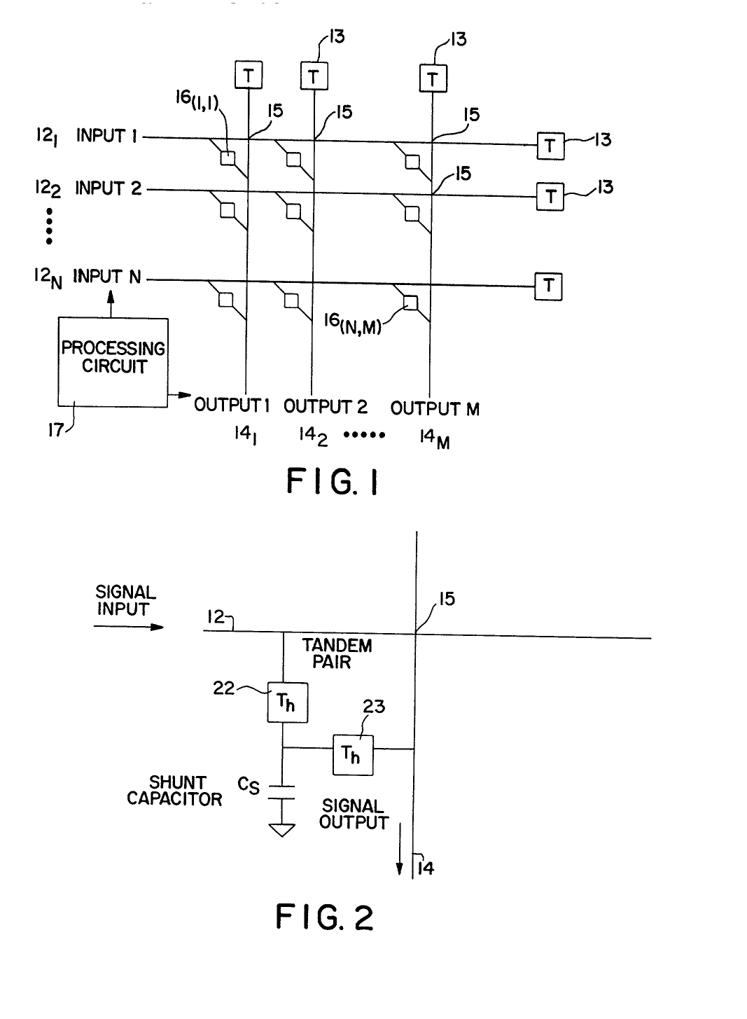

Briefly, the structure and function according to the present invention suppresses the spurious cross coupling σ by using a tandem switch design for the crosspoint switch elements, as shown in FIG. 2. Instead of a simple ON-OFF switch (as used in the basic crossbar of FIG. 1), a tandem switch structure with a shunt capacitor is used to effectively short the crosstalk to ground.

2. The Structure

FIG. 2 shows a crosspoint switch element according to a preferred embodiment of the present invention. For clarity, FIG. 2 depicts only a single crosspoint in a multi-crosspoint array. At each of the N×M cross-points 15 there is provided a tandem pair of thyristors 22, 23, and a shunt capacitor Cs. Depending upon the application, the shunt capacitor Cs may be shared among two or more thyristors. This is a new variety of N×M analog crossbar switch which uses a pair of semiconductor switches at each crosspoint to direct any of N incoming signals to any of M outgoing lines. The preferred embodiment may be utilized in the circuitry described in U.S. patent application Ser. No. 09/788,296, filed Feb. 26, 2001 (incorporated herein by reference).

The use of a (tandem) pair of switches at each crosspoint in conjunction with a shunt capacitor effectively shorts out spurious crosstalk signals coupled from other inputs without appreciably attenuating the desired signal output. The degree of attenuation of crosstalk possible by the use of tandem switches at each crosspoint greatly exceeds any known method which uses single switches at each crosspoint. Finally, the preferred embodiment may be used with the novel addressing scheme taught in U.S. patent application Ser. No. 09/788,298, filed Feb. 16, 2001 (incorporated herein by reference), leading to a completely passive, low power analog tandem crossbar switch design with ultra low crosstalk and ultra low channel bit error rates without any need for costly, high power digital error correction circuitry.

3. The Functions

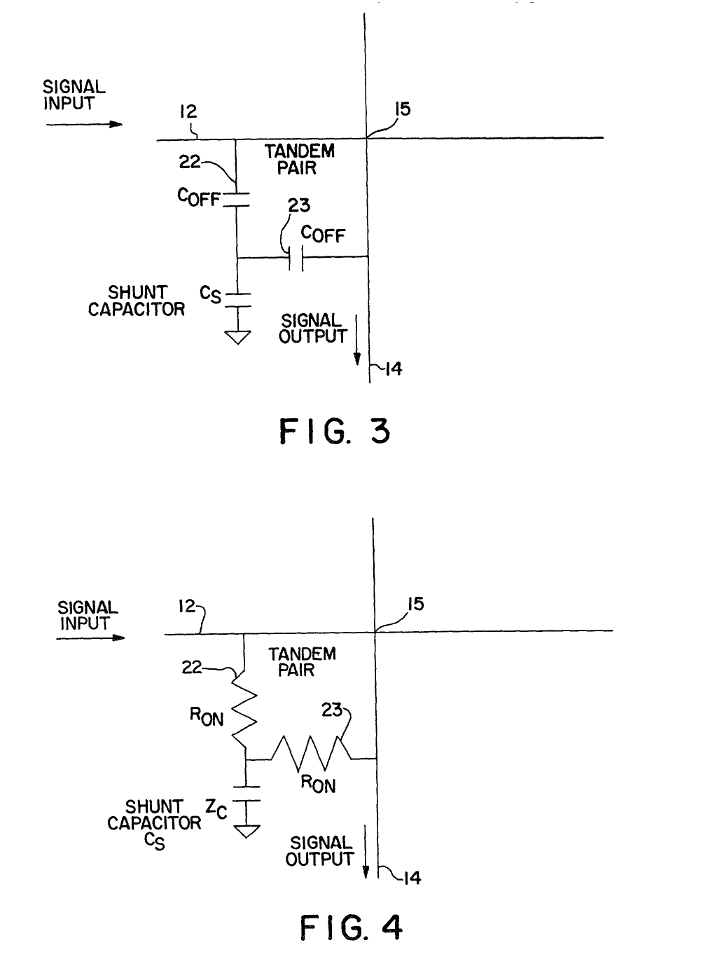

When both thyristors 22, 23 are turned OFF at a crosspoint 15, the tandem structure permits very little spurious coupling of crosstalk into the switch output 14. See the equivalent circuit diagram shown in FIG. 3. The reason is that the shunt capacitance Cₛ is much larger than the parasitic capacitance C_{OFF} of the OFF thyristor, so most of the crosstalk current at Node 1 (15) is shunted to ground by the low impedance path through Cₛ. Typically, the value of Cₛ is 100 fF (femto Farads), which is ten times the typical value of C_{OFF}=10 fF. This leads to a tenfold reduction in the crosstalk at every cross-point node, resulting in a 20 dB improvement in switch signal to noise ratio.

Conversely, when both thyristors are turned ON (see the equivalent circuit diagram shown in FIG. 4), the signal input is switched to the switch output. At the frequencies of interest, e.g., f=40 GHz, the series resistance Rₒₙ of the ON thyristor is much smaller than the impedance Z_{C} of the parallel shunt capacitance. Typically Rₒₙ=3 ohms, Cₛ=100 fF, Z_{C}=40 ohms. Hence most of the signal is switched to the signal output, and very little is lost due to the shunt capacitor Cₛ Indeed, the signal current divides at Node 1 in proportion to the ratio of impedances R_{ON}, Z_{C}, and where R_{ON}<<Z_{C}.

This new design is able to suppress the spurious cross coupling due to the parasitic capacitance of the thyristors to such a degree that the signal to noise ratio of the switch is limited only by the nearest neighbor coupling of the transmission lines on the substrate, and not by the OFF thyristor capacitance. By using a good transmission line design, such as microstrip or stripline (see “RF and Microwave Coupled Line Circuits”, Mongia, Rajesh. Artech House, 1999, incorporated herein by reference) over a low dielectric substrate, extremely large passive crossbar switches can be fabricated with signal to noise ratios exceeding 38 dB for a 1 K×1 K switch at 10 Gbs or a 256×256 switch at 40 Gbs.

4. Analytical Model of the Tandem Switch Element

Using the model shown in FIG. 3 for the tandem switch element, the spurious crosstalk power coupled into a given signal output for a unit signal input due to the coupling of any of the other (N-1) input signals is given by the following expression:

CP(f)=4(2πfCZ₀)²/{[4(2π+C_{S}/C)−(2πfZ₀)²CCₛ]²⁺16(2πf(C+Cₛ)Z₀)²} (5)

where

2πf is the angular frequency

C=parasitic capacitance of an OFF crosspoint switch

C_{S}=shunt capacitance

Z₀=characteristic impedance of the lines.

It is instructive to compare the crosstalk power given by the above equation (5) with that of the basic crossbar switch crosstalk power given by equation (1). For example, at 10 GHz, the crosstalk given by equation (1) (assuming a parasitic OFF thyristor capacitance of 10 femto Farads (fF)), we obtain CP(10 GHz)=-36.0 dB. For the tandem switch according to the preferred embodiment, using the same thyristor capacitance C=10 fF, and a shunt capacitance Cₛ=100 fF, we obtain CP(10 GHz)=−57.6 dB. Hence the tandem switch design has reduced the crosstalk by 21.6 dB. This is very close to the 20 dB improvement predicted by the simple current divider model given above.

The shunt capacitor Cs also has an effect on the signal attenuation. Analogous to equation (1), the signal power at the output of the tandem switch, given an input signal with unit power is:

SP(f)=4Z₀²/{(Z₀+2R)²[16+(2πfCₛ)²(Z₀+2R)²]} (6)

Where

R=ON resistance of the thyristor crosspoint switch

Cₛ=shunt capacitance

Z₀=characteristic impedance of the lines.

For example, at 10 Gbs with C=100 fF, the signal output power is −7.0 dB compared to the value of −6.6 dB given by equation (2) for the single crosspoint switch. Hence, the insertion loss of the Tandem switch is increased by only 0.4 dB. Once again, this result confirms the prediction of very little insertion loss as discussed above.

5. Monolithic Implementation of the Tandem Switch

Important to the practical implementation of the invention is the availability of a technology which allows the fabrication of series and shunt thyristor switches on an insulating substrate, such as glass, along with thin film shunt capacitors. For example, the Silicon on Glass (SOG) technology (see SiGen Corporation, Campbell, Calif. http://www.sigen.com/products.html, (200 mm SOG wafers, the available Si layer thickness ranges from 300 Angstroms to 2 micron with appropriate buried oxides (usually in the range from 1000 Angstroms to 1 micron)) incorporated herein by reference) is commercially available, and provides a viable process method for the fabrication of a tandem switch.

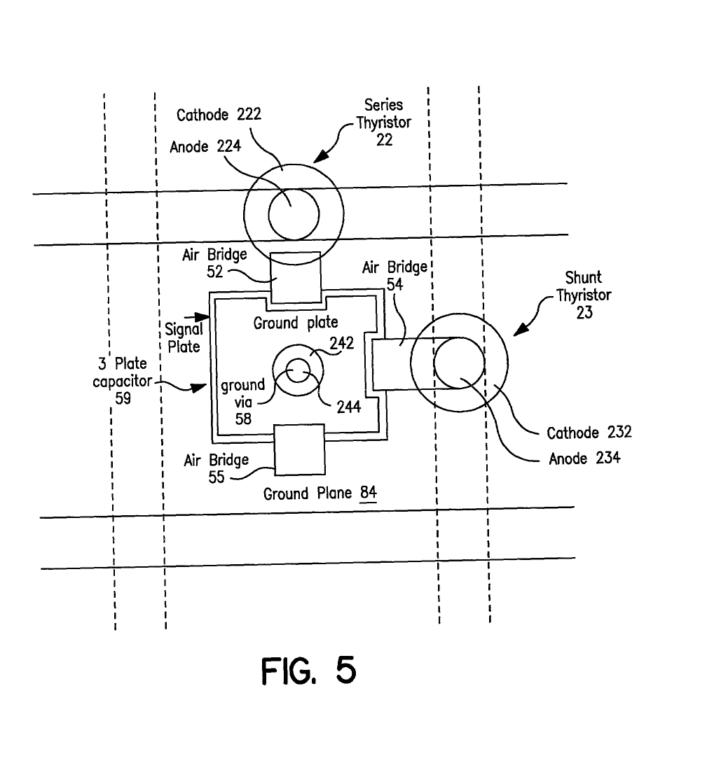

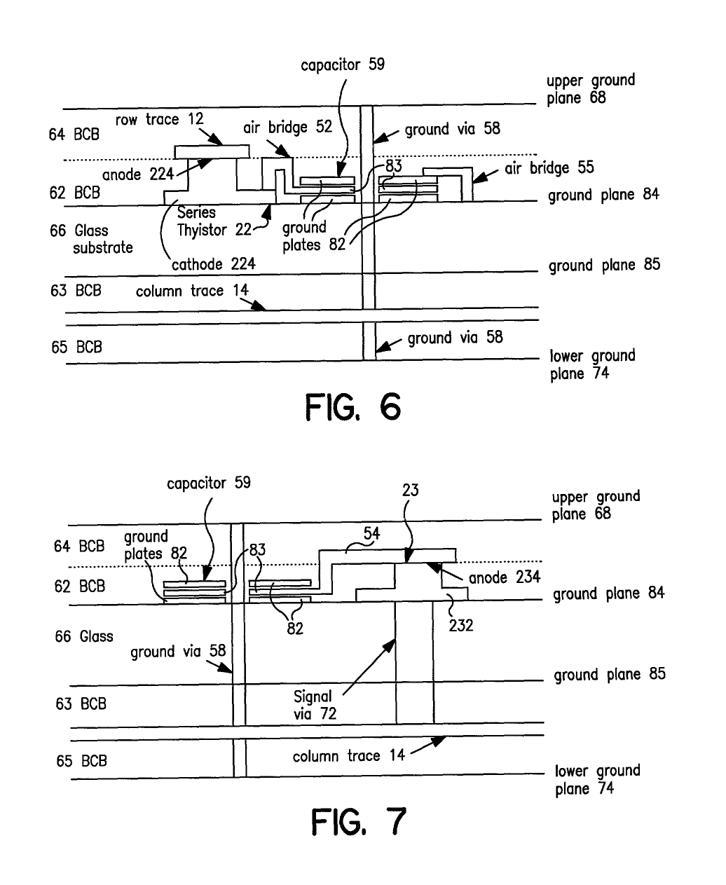

FIG. 5 shows a top view of a SOG implementation of the tandem switch, and FIGS. 6 and 7 show side views thereof. The series thyristor 22 and the shunt thyristor 23 shown in the figures are fabricated on a separate silicon wafer, and then bonded to the glass (see, for example, EVG Wafer Bonding Systems. EV 500 Series http://www.ev-global.com/products/waferbonding.htm, incorporated herein by reference), and patterned with Reactive Ion Etching (RIE), dry etch, and wet etch techniques. Thyristor 22 has cathode 222 and an anode 224. Thyristor 23 has a cathode 232 and an anode 234. A ground plane 84 is deposited on the front side surface of the glass substrate 66, along with a three plate thin film capacitor 59. The capacitor 59 has a middle plate 83, and two ground plates 82 which are connected to ground, as will be described below.

Air bridges 52 and 54 are fabricated which connect the cathode 222 of the series thyristor 22 to the to the middle plate 83 of the three plate thin film capacitor 59, and also to the anode 234 of the shunt thyristor 23. An air bridge is a method used to connect subcircuits on the same level or on two different levels of a monolithic integrated circuit. It is able to provide an air gap between the air bridge and a conducting layer below. For example, in FIG. 6, the air bridge 52 connects the cathode 222 to the middle plate 83 of the thin film capacitor 59. In this way, the air bridge is able to pass over the ground plane 84 which is on the glass substrate 66 and connect 222 and 83 without shorting to ground. Furthermore, an air bridge 55 connects the top ground plate of 82 of the three plate capacitor to the bottom ground plate 242 and ground plane 84. The air bridge is fabricated by depositing photoresist on the areas where the air bridge must pass over, and patterning it so that the subcircuit is exposed where the air bridge must connect to the subcircuit. Then, a thin (100 A) layer of gold is sputtered onto the whole wafer. This gold layer bonds to the subcircuit and this makes the connection. Then, another layer of photoresist is deposited and patterned. Next, the conducting trace of the air bridge is plated on. Finally, the photoresist underneath the air bridge is dissolved away, leaving the air bridge which connects the two given subcircuits.

After, the air bridge formation, a thin film 62 (FIG. 6) of a low dielectric substance such as BCB (see, for example, Dow Chemical Benzocyclobutene Product Announcement http://www.dow.com/cyclotene/, Benzocyclobutene (BCB)-based polymer dielectrics Cyclotene Resins are high-purity polymer solutions that have been developed for microelectronics applications. The resins are derived from B-staged bisbenzocyclobutene (BCB) monomers and are formulated as high-solids, low-viscosity solutions) is deposited, forming a surface on which the row traces 12_{N} are fabricated. In the preferred embodiment, the row traces 12_{N} are fabricated on the front side as stripline structures, and the column traces 14_{N} are fabricated on the backside as stripline. The row traces connect directly to the anodes 224 of the series thyristors. Next, another layer 64 of BCB is deposited, and ground vias 58 are etched and plated through to the glass substrate 66. Note that any required ground traces may connect the ground vias 58 with the lower plate 242 of capacitor 59. Finally the upper ground plane 68 is deposited which connects to the ground vias 58. Preferably, there is one ground via 58 for every unit cell.

The back side of the wafer is further processed by etching ground vias 58 and signal vias 72 (FIG. 7), and plating them up through the substrate, then depositing the backside ground plane 85. Next, a thin BCB layer 63 is deposited, forming a backside surface for the column traces 14_{N}. The remaining segment of the signal via 58 is then etched through the BCB layer 63. The column traces 14_{N} are then fabricated on this surface, connecting to the signal vias 58. Note that the signal via 72 now connects the cathode 232 of the shunt thyristor 23 on the front side to the column trace 14 on the back side.

Next, the last layer 65 of BCB is applied to the back side, and ground vias 58 are etched down to the substrate 66 and plated up. Finally the back side (lower) ground plane 74 is deposited. At each unit cell, there is now a ground via 58 which passes though the upper BCB layers 62, 64, the substrate layer 66, and the lower BCB layers 63, 65, and which connects the four ground planes 68, 84, 85, and 74, as shown in FIGS. 6 and 7, giving good isolation between adjacent rows or columns.

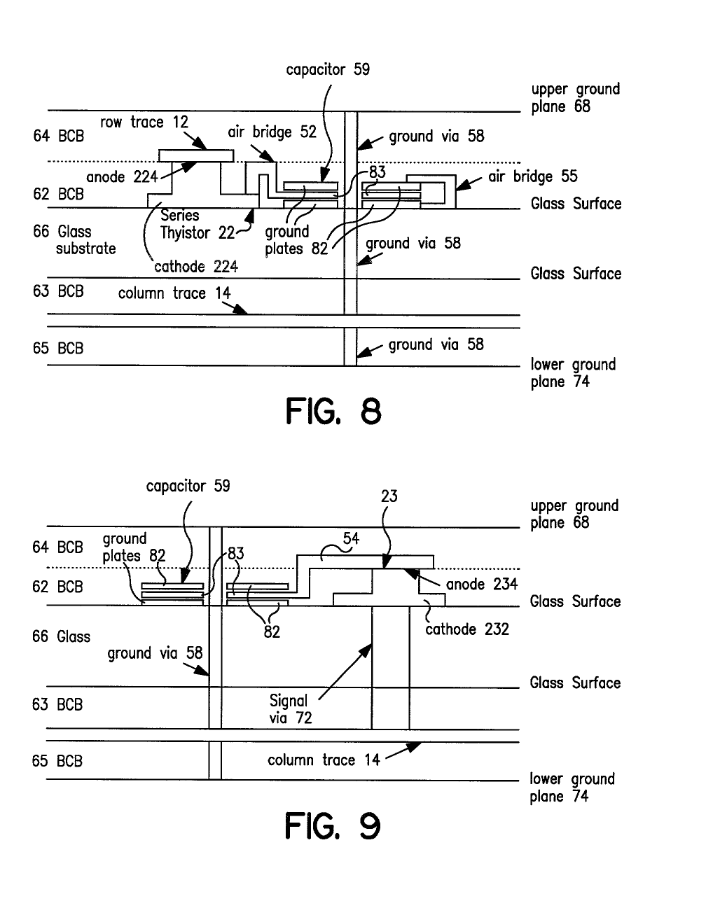

The row traces 12_{N} in conjunction with the upper (front side) ground plane 68 form a stripline transmission line system with a well defined characteristic impedance of 50 ohms, and similarly for the column traces 14_{N} on the backside. This embodiment is only one realization of the Tandem Switch design. A similar fabrication approach could be used to implement the transmission lines as microstrip, instead of stripline. In this case, there may be only two ground planes, and no ground plane surface needs to be deposited on the front and back surfaces of the glass substrate 66. This is shown in FIGS. 8 and 9.

In this case, the top and bottom ground plates 82 of the three plate capacitor are connected by the air bridge 55, and the bottom plate 242 is connected to ground by the ground via 58. The upper ground plane 68 and the lower ground plane 74 are connected by the ground 58.

Note that the structure of the three plate capacitor 59 is advantageous to preserve the transmission line structure of the transmission lines on the frontside surface. The top and bottom plates 82 of the three plate capacitor 59 are connected to ground so that the electrical field lines on the frontside transmission lines will terminate on a grounded surface. Without the top ground plate, these field lines would terminate on the signal bearing middle plate, which would prevent the design of a transmission line structure with a characteristic 50 ohm impedance. This has been verified by simulation.

The row traces 12_{N} in conjunction with the upper (front side) ground plane 68 form a microstrip transmission line system with a well-defined characteristic impedance of 50 ohms, and similarly for the column traces 14_{M} on the backside. (Note that N may equal M). This embodiment is only one realization of the tandem switch invention. A very similar fabrication approach could be used to implement the transmission lines as stripline, instead of microstrip, see FIGS. 5, 6, and 7. This would be useful for fabrication of a Tandem Switch able to operate at extremely high frequencies, where the stripline gives better isolation and lower crosstalk than microstrip.

6. Summary of Alternate Tandem Switch Designs

As discussed above, the spurious cross coupling due to the parasitic capacitance of the OFF thyristor switches in an N×M crossbar switch can be effectively eliminated in accordance with the present invention. The remaining crosstalk in the system is due to nearest neighbor coupling of adjacent transmission lines through their mutual capacitance and inductance (see page 147, “RF and Microwave Coupled Line Circuits”, Mongia, Rajesh. Artech House, 1999).

The above-noted effect is most pronounced at high frequencies, e.g., 40 GHz, and for large switch sizes, e.g.,1K×1K. The implementation of the row and column transmission lines as stripline structures should exhibit smaller coupling than similar structures implemented as microstrip structures. However, stripline generally suffers from greater insertion loss due to the smaller traces, assuming a constant dielectric thickness. Hence stripline structures require a small pitch between lines (typically 4 mils) in order to reduce the length of the worst case signal path. Since insertion loss scales as dB/length, the smaller pitch greatly reduces insertion loss. However, it is more difficult to make chips with such a small pitch (with correspondingly smaller yields), and also the smaller pitch makes the chip more difficult to package, i.e., to design matched transitions from the chip to the board.

The tandem switch design according to the present invention may be adapted to large scale crossbar switches, up to 1K×1K at 10 Gbs and 256×256 at 40 GBs. The following designs will be discussed:

1. 256×256 tiled switch at 10 GBs (10 mil pitch, microstrip, gold)

2. single chip 256×256 switch at 40 Gbs (4 mil pitch, stripline, gold)

3. 1024×10²⁴ tiled switch at 10 Gbs (4 mil pitch, stripline, silver)

Note that all of these designs are completely passive, requiring no amplification stages in the switch fabric proper, although such amplification stages may be provided for some applications. The switch is driven by external Optical Interface Cards (OIC) which preferably contain all the amplifiers. Hence, Designs # 1, 2, 3 may be implemented as self-contained, single board designs which connect the passive switch fabric to the array of OIC cards with low-loss, high-isolation coaxial cables.

Design # 1 yields a 256×256 switch at a 10 Gbs rate using 10 mil pitch, microstrip transmission lines, gold traces, and a dielectric (BCB) thickness of 10 microns. Design # 2 yields a faster 40 Gbs switch using a 4 mil pitch, stripline transmission lines, gold traces, and a BCB thickness of 20 microns. The 4 mil pitch, however, may impact yields, as well as packaging design. Finally, Design # 3 yields a large, passive 1K×1K switch by using stripline structure implemented with a more sophisticated process with smaller yields, i.e., 4 mil pitch, silver traces and a BCB thickness of 40 microns.

In all of these cases, the switch SNR is much better than the 18 dB required to achieve a 10⁻¹⁵ Bit Error Rate (BER). Hence, no expensive, high power digital forward error correction (FEC) circuits are required, because of the excellent SNR obtained for all three designs. Furthermore, the insertion loss for Designs # 1, 2, 3 is −25 dB, −22 dB, 40 dB, respectively. This is well above the thermal noise floor of the final amplification stage in the OIC cards (typically −70 dB). Hence the BER is not appreciably increased by switch crosstalk or OIC thermal noise.

7. Systems Analysis of Tandem Switch Designs

Simulations have been run for the three designs summarized above, and the results are shown below in Table 1. For each design, the worst-case insertion loss of the output signal and the worst-case total crosstalk power have been calculated. The switch SNR is then calculated using equation (3), and the Bit Error Rate (BER) is calculated using a standard formula, for example, as found in “Optical Fiber Communications”, Gerd Keiser, McGraw Hill, 2000, Page 286 (incorporated herein by reference). The pitch, conductor trace material, transmission line type, and dielectric (BCB) thickness are as indicated. It is clear that that all of these designs are viable candidates for large scale, high speed switching applications such as routers, telephone switching networks, etc.

TABLE 1
Systems Analysis of Tandem Switch Designs

| size | Data rate | insertion | crosstalk | pitch | trace | type | BCB thick | SNR |
|---|---|---|---|---|---|---|---|---|
| 256 × 256 | OC 192 | −25 dB | −55 dB | 10 mils | gold | microstrip | 20 microns | 30 dB |
| 256 × 256 | OC 768 | −22 dB | −62 dB | 4 mils | gold | stripline | 20 microns | 40 dB |
| 1 K × 1 K | OC 192 | −40 dB | −78 dB | 4 mils | silver | stripline | 40 microns | 38 dB |

8. Addressing and Control of Tandem Switch

The tandem pair of thyristors at each crosspoint can be addressed and controlled in the same manner as described in the patent application in U.S. patent application Ser. No. 09/788,298, filed Feb. 16, 2001. Because the tandem pair of thyristors are connected in series, they can be turned on or off by applying control pulses on the rows and columns, using, for example, addressing circuit 17 (FIG. 1). These control pulses will be approximately twice the voltage of the control pulses required to control a single thyristor switch element. The tandem pair can then be biased ON or OFF by supplying a constant current to each series connected pair, the same as a single crosspoint switch is biased in U.S. patent application Ser. No. 09/788,298.

9. Conclusion

Thus, what has been described is a switching array method and apparatus capable of high signal speeds and dense integration, but with ultra low crosstalk, and to methods of making and assembling such a switch array.

The individual components shown in outline or designated by blocks in the attached Drawings are all well-known in the microwave switching arts, and their specific construction and operation are not critical to the operation or best mode for carrying out the invention.

While the present invention has been described with respect to what is presently considered to be the preferred embodiments, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. Telecommunications switching apparatus for an array having a plurality of inputs and a plurality of outputs, comprising:
a plurality of switching elements, each coupled to a respective input and to a respective output; and
shunt capacitance structure coupled to the switching elements to suppress crosstalk between the inputs and the outputs.

2. Apparatus according to claim 1, wherein said shunt capacitance structure comprises a plurality of shunt capacitance elements, each coupled to a respective one of the switching elements and to ground.

3. Apparatus according to claim 2, wherein a shunt capacitance of each shunt capacitance element is greater than a parasitic capacitance of the respective switching element.

4. Apparatus according to claim 2, wherein each switching element has an ON resistance which is less than an impedance of the respective shunt capacitance element.

5. Apparatus according to claim 1, further comprising another plurality of switching elements respectively coupled in tandem with said plurality of switching elements.

6. Apparatus according to claim 5, wherein each of said another plurality of switching elements is coupled in series with a respective one of said plurality of switching elements, between said respective input and said respective output.

7. Apparatus according to claim 6, wherein said shunt capacitance structure comprises a shunt capacitor coupled to each of the switching elements and to ground.

8. Apparatus according to claim 1, wherein said switching apparatus is disposed on multiple horizontal levels, with the plurality of switching elements being disposed at switch crosspoints.

9. Apparatus according to claim 8, wherein said plurality of switching elements comprises a plurality of series thyristors and a plurality of shunt thyristors, and wherein said shunt capacitance structure comprises a plurality of thin film capacitors disposed on a substrate.

10. Apparatus according to claim 1, wherein said plurality of switching elements comprises 1000 switching elements.

11. Apparatus according to claim 1, further comprising structure which row-column addresses said plurality of switching elements.

12. Apparatus according to claim 1, wherein said switching apparatus comprises a microwave switching apparatus.

13. Apparatus according to claim 1, wherein said switching apparatus is disposed on a stripline integrated circuit.

14. Microwave switching apparatus in an array having plural inputs and plural outputs crossing each other at a plurality of crosspoints, comprising:
a plurality of first switches, each disposed at a corresponding crosspoint between a respective input and a respective output; and
a plurality of second switches, each disposed in series with a respective first switch.

15. Apparatus according to claim 14, wherein each first switch comprises a series thyristor, and wherein each second switch comprises a shunt thyristor.

16. Apparatus according to claim 15, further comprising a plurality of shunt capacitors, each coupled to a respective shunt thyristor.

17. Apparatus according to claim 16, wherein said switching apparatus is disposed in a monolithic integrated circuit.

18. Apparatus according to claim 16, wherein a shunt capacitance of each shunt capacitor is larger than a parasitic capacitance of each of the respective first and second switches when OFF.

19. Apparatus according to claim 16, wherein an impedance of each shunt capacitor is larger than a series resistance of each of the respective first and second switches when ON.

20. Apparatus according to claim 16, wherein said switching apparatus has a signal-to-noise ratio greater than 30 dB.

21. A microwave switch array, comprising:
a substrate;
a plurality of signal inputs disposed on said substrate;
a plurality of signal outputs disposed on said substrate and crossing said plurality of signal inputs at a plurality of crosspoints;
a plurality of tandem semiconductor switches respectively disposed at the crosspoints, each tandem switch comprising first and second series-connected switches; and
a plurality of semiconductor shunt capacitance elements respectively disposed at the crosspoints and coupled to respective first and second switches and to ground, to ground noise signals.

22. A switch array according to claim 21, wherein each said first and second switch comprises a thyristor.

23. A switch array according to claim 21, wherein, where a shunt capacitance of each shunt capacitance element is Cₛ, and wherein a parasitic capacitance of a respective OFF thyristor is C_{OFF}, Cₛ>>C_{OFF}.

24. A switch array according to claim 21, wherein, where a parallel shunt capacitance is Z_{C}, and wherein a series resistance of a respective ON thyristor is R_{ON}, Z_{C}>R_{ON}.

25. A switch array according to claim 21, wherein said substrate has no amplification circuitry disposed thereon.

26. A switch array according to claim 21, wherein said plurality of signal inputs and said plurality of signal outputs comprise stripline transmission lines.

27. A switch array according to claim 21, wherein said plurality of signal inputs and said plurality of signal outputs comprise microstrip transmission lines.

28. A telecommunications switching method in an array having (i) a plurality of inputs and a plurality of outputs, (ii) a plurality of switching elements, each coupled to a respective input and to a respective output, and (iii) shunt capacitance structure coupled to the switching elements, comprising the steps of:
switching ON a switching element to pass a signal from a respective input to a respective output;
grounding shunt capacitance structure in switching elements adjacent to the ON switching element to suppress crosstalk between inputs and the outputs adjacent said respective input and said respective output.

29. A method according to claim 28, wherein said shunt capacitance structure comprises a plurality of shunt capacitance elements, each coupled to a respective one of the switching elements and to ground.

30. A method according to claim 29, wherein a shunt capacitance of each shunt capacitance element is greater than a parasitic capacitance of the respective switching element.

31. A method according to claim 29, wherein each switching element has an ON resistance which is less than an impedance of the respective shunt capacitance element.

32. A method according to claim 28, wherein another plurality of switching elements are respectively coupled in tandem with said plurality of switching elements, and wherein said switching ON step includes the step of switching ON one of said plurality of another switching elements with the ON switching element.

33. A method according to claim 32, wherein each of said another plurality of switching elements is coupled in series with a respective one of said plurality of switching elements, between said respective input and said respective output.

34. A method according to claim 33, wherein said shunt capacitance structure comprises a shunt capacitor coupled to each of the switching elements and to ground.

35. A method according to claim 28, wherein said switching apparatus is disposed on multiple horizontal levels, with the plurality of switching elements being disposed at switch crosspoints.

36. A method according to claim 35, wherein said plurality of switching elements comprises a plurality of series thyristors and a plurality of shunt thyristors, and wherein said shunt capacitance structure comprises a plurality of thin film capacitors disposed on a substrate.

37. A method according to claim 28, further comprising the step of row-column addressing said plurality of switching elements to cause said switching ON step.

38. A microwave switching method in an array having plural inputs and plural outputs crossing each other at a plurality of crosspoints, comprising the steps of:
providing a plurality of first switches, each disposed at a corresponding crosspoint between a respective input and a respective output;
providing a plurality of second switches, each disposed in series with a respective first switch;
switching ON at least one of said plurality of first switches and at least one of plurality of second switches to cause a signal to flow from an input to an output; and
grounding noise in inputs and outputs which are unconnected to the ON switches.

39. A method according to claim 38, wherein each first switch comprises a series thyristor, and wherein each second switch comprises a shunt thyristor.

40. A method according to claim 39, further comprising the step of providing a plurality of shunt capacitors, each coupled to a respective shunt thyristor, to perform said grounding step.

41. A method according to claim 40, wherein said steps are performed on a monolithic integrated circuit.

42. A method according to claim 40, wherein a shunt capacitance of each shunt capacitor is larger than a parasitic capacitance of each of the respective first and second switches when OFF.

43. A method according to claim 40, wherein an impedance of each shunt capacitor is larger than a series resistance of each of the respective first and second switches when ON.

44. A method according to claim 40, wherein said switching method provides output signals having a signal-to-noise ratio greater than 30 dB.

45. A microwave switching method in an array having (i) a substrate, (ii) a plurality of signal inputs disposed on said substrate, (iii) a plurality of signal output disposed on said substrate and crossing said plurality of signal inputs at a plurality of crosspoints, (iv) a plurality of tandem semiconductor switches respectively disposed at the crosspoints, each tandem switch comprising first and second series-connected switches, and (v) a plurality of semiconductor shunt capacitance elements respectively disposed at the crosspoints and coupled to respective first and second switches and to ground, comprising the steps of:
switching ON respective first and second series-connected switches disposed at a crosspoint to pass a signal from a respective input to a respective output; and
grounding noise signals in OFF first and second series-connected switches through their respective shunt capacitance elements.

46. A method according to claim 45, wherein each said first and second switch comprises a thyristor.

47. A method according to claim 45, wherein, where a shunt capacitance of each shunt capacitance element is Cₛ, and wherein a parasitic capacitance of a respective OFF thyristor is C_{OFF}, Cₛ>>C_{OFF}.

48. A method according to claim 45, wherein, where a parallel shunt capacitance is Z_{C}, and wherein a series resistance of a respective ON thyristor is R_{ON}, Z_{C}>>R_{ON}.

49. A method according to claim 45, wherein no amplification step is performed on said substrate.

50. A method of making a microwave switch array, comprising the steps of:
providing a substrate;
forming a plurality of signal inputs on said substrate;
forming a plurality of signal output on said substrate and crossing said plurality of signal inputs at a plurality of crosspoints;
forming a plurality of tandem semiconductor switches respectively disposed at the crosspoints, each tandem switch comprising first and second series-connected switches; and
forming a plurality of semiconductor shunt capacitance elements respectively at the crosspoints and coupled to respective first and second switches and to ground.

51. A method according to claim 50, wherein each said first and second switch comprises a thyristor.

52. A method according to claim 50, wherein, where a shunt capacitance of each shunt capacitance element is Cₛ, and wherein a parasitic capacitance of a respective OFF thyristor is C_{OFF}, Cₛ>>C_{OFF}.

53. A method according to claim 50, wherein, where a parallel shunt capacitance is Z_{C}, and wherein a series resistance of a respective ON thyristor is R_{ON}, Z_{C}>>R_{ON}.

54. A method according to claim 50, wherein said substrate has no amplification circuitry disposed thereon.

55. A method according to claim 50, wherein said plurality of signal inputs and said plurality of signal outputs comprise stripline transmission lines.

56. A method according to claim 50, wherein said plurality of signal inputs and said plurality of signal outputs comprise microstrip transmission lines.

57. A telecommunications switching array comprising:
a plurality of inputs;
a plurality of outputs;
a plurality of switching elements, each coupled to a respective input and to a respective output; and
shunt capacitance structure coupled to the switching elements to suppress crosstalk between the inputs and the outputs.

58. An array according to claim 57, wherein said shunt capacitance structure comprises a three plate thin film capacitor having top and bottom plates grounded.

59. An array according to claim 58, further comprising a substrate disposed between said inputs and said outputs, and wherein said three plate thin film capacitor is disposed over an upper surface of said substrate.

60. An array according to claim 57, wherein said inputs and said outputs comprise stripline traces.

61. An array according to claim 57, wherein said inputs and said outputs comprise microstrip traces.

62. An array according to claim 57, wherein said a plurality of inputs, said plurality of outputs, said plurality of switching elements, and said shunt capacitance are formed in an integrated circuit, and further comprising:
an upper ground plane;
another ground plane, disposed under said upper ground plane;
a glass substrate, disposed under said another ground plane;
a further ground plane, disposed under said glass substrate;
a lower ground plane, disposed under said further ground plane;
a plurality of row traces disposed between said upper and said another ground plane; and
a plurality of column traces disposed between said lower ground plane and said further ground plane.

63. An array according to claim 57, wherein said a plurality of inputs, said plurality of outputs, said plurality of switching elements, and said shunt capacitance are formed in an integrated circuit, and further comprising:
an upper ground plane;
another ground plane, disposed under said upper ground plane;
a glass substrate, disposed under said another ground plane;
a further ground plane, disposed under said glass substrate;
a lower ground plane, disposed under said further ground plane;
a plurality of column traces disposed between said upper and said another ground plane; and
a plurality of row traces disposed between said lower ground plane and said further ground plane.
